(19) United States
(12) Patent Application Publication
(10) Pub. No.: US 2006/0219623 A1
(43) Pub. Date: Oct. 5, 2006

(54) Filter assembly with integrated debris cup for sanitary fittings

(76) Inventors: Frank A. Seggio, Wayside, NJ (US); Juergen Sponheimer, Klausen (DE)

Correspondence Address: AMERICAN STANDARD INC., ONE CENTENNIAL AVENUE, PISCATAWAY, NJ, 08855-6820, US

(21) Appl. No.: 11/387,337

(22) Filed: Mar. 23, 2006

Related U.S. Application Data
(60) Provisional application No. 60/666,348, filed on Mar. 30, 2005.

(51) Int. Cl. B01D 29/00; E03C 1/26; A47K 1/14; B01D 35/00

(52) U.S. Cl. 210/348; 4/292; 4/295; 210/454

(57) ABSTRACT

The present invention discloses a filter assembly for use in sanitary fittings such as faucets, bath and shower valves, flush valves and equivalents thereof. A debris cup is releasably attached to a cap so as to retain a filter means thereby. The debris cup and cap are connected by one of a threaded connection, friction fit, snap-tight engagement or any combination thereof. The filter means includes a cylindrical screen member with a plurality of apertures defined through an outer circumferential surface thereof. The outer filter means surface, together with an internal circumferential surface of the debris cup, defines a debris reservoir that captures and isolates effluents therein. The debris cup, cap and filter means are manufactured and installed as an integral unit that is singularly removable from a sanitary housing, thereby removing all of the debris collected in the debris reservoir without negatively affecting the water delivery line in fluid communication with the sanitary fitting.

This application claims priority to Applicant's U.S. application Ser. No. 60/666,348, filed Mar. 30, 2005, and incorporated by reference herein

### FIELD OF THE INVENTION

The present invention is directed to a filter used with a sanitary fitting or commensurate device. More particularly, the present invention is directed to a filter assembly having a debris cup detachably integral therewith for removing effluents from a flowthrough liquid. Such filter configuration reduces manufacturing, installation and maintenance costs associated with sanitary devices and simultaneously optimizes the capture of undesirable debris. In this configuration, the present invention prevents undesirable accumulation of deleterious fluid elements and thereby enhances the hygienic condition of liquid for human and animal consumption.

### BACKGROUND OF THE INVENTION

Increased concern about the consumption of potable water remains a dilemma for water agencies, commercial building owners, homeowners, residents and sanitaryware manufacturers. An increasing global population has negatively affected the amount and quality of suitable water. Effluents in water supplies have drastically altered fresh water supplies and the overriding need to sustain a healthy population is evident in the filter devices that are pervasive in sanitary products.

Filter devices are particularly well known for use with faucets, water pitchers and other fluid conveyance devices as effective and inexpensive tools for the removal of harmful effluents. Conventional filters devices often employ screen media made from wire mesh that undesirably allows accumulation of debris thereon. The aggregate debris substantially reduces the available surface area for throughflow of clean fluid and thereby impedes the egress of clean fluid from the screen. In addition, water pressure acting on the lodged debris and screen wires can create enough force to deform or crush the screen, thereby further reducing the throughflow and/or compromising the filter seal to allow passage of debris thereby. The repeated occurrences of these clogged conditions incur substantial temporal and fiscal investments toward the maintenance of sanitary mechanisms in which conventional screen filters are employed.

In an attempt to overcome these drawbacks, U.S. Pat. No. 5,398,720 to Cole et al. (“Cole”) discloses a faucet strainer employed within a conventional faucet assembly having a valve with a valve closure. The strainer includes a body having straining means defined therein, desirably in the form of one or more slots or apertures. The straining means is defined downstream of a fluid supply that delivers fluid and debris to the faucet assembly. The straining means allows fluid flow though the strainer body while retaining debris thereby for collection in a receptacle that is carried by the body and disposed downstream of the straining means.

Although Cole addresses the problem of impeded faucet performance due to debris aggregation, the faucet strainer disclosed therein still permits large amounts of debris to enter the fluid stream. Cole advises that the slots or apertures therein are desirably at least two times as large as the fluid flow area that exists between a valve closure and valve seat when the valve is fully opened. In this configuration, Cole claims that the extra slot area allows adequate flow even if debris accumulates in the receptacle (“It will be appreciated over that over time, the debris, such as wood chips, collected within receptacle 57 may eventually break down and be harmlessly flushed out of the faucet assembly.” See Cole, column 4, lines 30 to 33.) Thus, Cole continues to allow entry of potentially harmful debris into the fluid stream.

In addition, Cole omits any teaching concerning maintenance of the faucet strainer and, namely, cleaning of the filtering section thereof as well as clearance of the debris collected in the receptacle. The faucet strainer taught by Cole undesirably permits deleterious debris of smaller size into the water supply, as the device must be fully disassembled for effective cleaning. Thus, discharge of accumulated debris during cleaning of the Cole device actually contributes to clogged conditions and consequential deterioration in faucet valve operation. The prevalence of such clogged conditions proves inconducive to hygienic fluid conditions and requires frequent cleaning by maintenance personnel. During cleaning, accumulated debris often becomes dislodged and enters the fluid path to the detriment of the end user's health. Additional clogging often occurs further downstream and severely interrupts the operation of fluid flow mechanisms in communication therewith (i.e., solenoid and manual valves, aerators and the like), thereby obviating any benefit that may have initially been derived from employment of the faucet strainer.

It is therefore desirable to provide a filter device that effectively removes effluents from a flowthrough liquid yet maintains enhanced flowthrough capability. Such a filter desirably reduces fiscal and temporal costs associated with manufacture, installation and maintenance thereof and correspondingly maintains optimal liquid sanitation.

### SUMMARY OF THE INVENTION

It is an advantage of the present invention to provide a filter assembly that effectively utilizes fluid flow to remove debris from filtration media and collect the debris in an integrated debris cup. Rather than just retaining debris in a receptacle as taught by the prior art, the present invention captures debris and permits complete removal thereof without entrance of any debris into the communicating water line.

It is another advantage of the present invention to provide a filter assembly that captures reduced sized particulates compared to conventional water filters. Such a filter assembly prevents the remnants of larger particles from entering the fluid stream, thereby preserving optimal hygienic standards for the output of a sanitary fitting.

It is a further advantage of the present invention to provide a filter assembly and debris cup that are installed within and removed from a sanitary fitting as an integral unit. Such a filter assembly reduces the complexity of manufacture and installation thereof and further reduces the time and money required for maintenance and/or replacement of existing sanitary filter assemblies. This is accomplished without attenuation of the assembly's filtering capabilities and, in fact, complements the assembly's enhanced filtering operation.

In accordance with these and other advantages, the present invention provides a filter assembly for use in sanitary fittings such as faucets, bath and shower valves, flush valves and equivalents thereof. The filter assembly comprises a debris cup releasably attached to a cap so as to retain a filter means therewithin. The debris cup includes a proximate extent at which a cap engagement means is defined and a distal extent from which filtered fluid departs the filter assembly. The proximate and distal extents define a longitudinal body therebetween. The body has an internal circumferential surface defining a lumen within which the filter means is disposed and at least one fluid ingress aperture that allows unimpeded passage of fluid therethrough. The cap has a securement extent that engages the debris cup proximate extent, and a gripping extent for grasping the filter assembly during installation, maintenance and removal thereof relative to a sanitary housing. The internal circumferential surface of the debris cup defines a debris reservoir relative to the filter means within which debris in a fluid is isolated. The debris cup, cap and filter means are unitarily removable from the sanitary housing.

The present invention also provides a sanitary installation, comprising a sanitary fitting and a filter assembly disposed in fluid communication therewith so as to remove debris from fluid prior to delivery of the fluid to the sanitary fitting. The filter assembly includes a debris cup as described above in combination with a sanitary fitting that is selected from a group of sanitary fittings, including, but not limited to, faucets, bath fillers, shower controls valves, flush valves and equivalents thereof.

The filter means taught by the present invention desirably comprises a generally cylindrical screen member having proximate and distal extents defining a screen member body therebetween. The screen member body has an outer circumferential surface adjacent the debris cup internal circumferential surface to thereby delineate the debris reservoir therebetween. The screen member body has a plurality of apertures defined through at least a portion thereof, and, more particularly, is desirably fabricated from a micro-perforated stainless steel sheet.

Various other advantages and features of the present invention will become readily apparent from the following detailed description, and the inventive features will be particularly evident from the appended claims.

### BRIEF DESCRIPTION OF THE DRAWINGS

FIG. 1 shows a perspective view of a filter assembly of the present invention having an integrated debris cup.

FIG. 2 shows an exploded view of the filter assembly of FIG. 1.

FIG. 3 is a cross-section of the filter assembly of FIG. 1 taken along line A-A.

FIG. 4 is a schematic of the filter assembly of the present invention with fluid flowing through the integrated debris cup thereof.

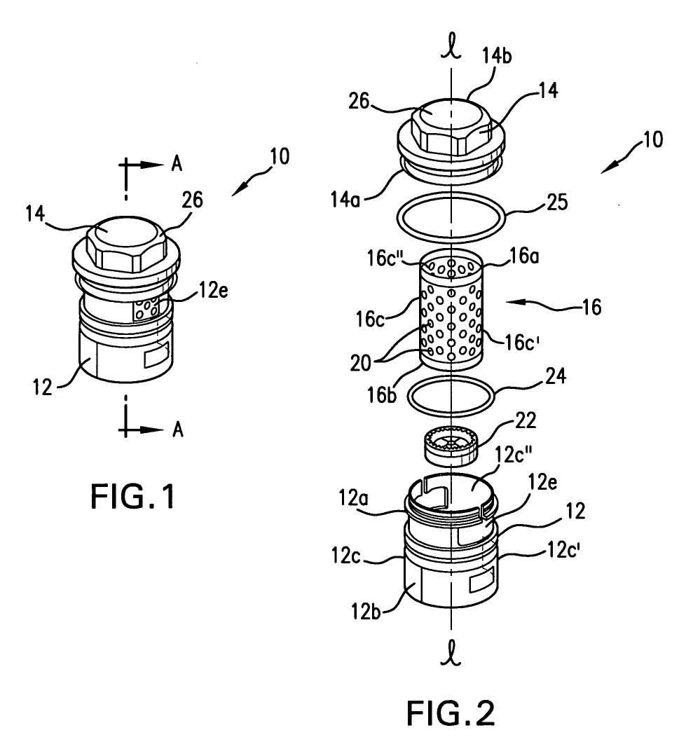

### DETAILED DESCRIPTION OF THE PREFERRED EMBODIMENTS

Now referring to the figures, wherein like numbers identify like elements, a filter assembly 10 of the present invention is provided with a debris collection means in the form of a debris cup 12 that is detachably connected to a corresponding cap 14 so as to retain a filter means therewithin. Debris cup 12 includes a proximate extent 12a at which a cap engagement means is defined and a distal extent 12b from which filtered fluid departs filter assembly 10. An optional pressure compensating flow regulator 22 is selectively installed adjacent distal extent 12b as desired, which regulator is selected from any one of a plurality of commercially available embodiments. Such flow regulator may be desirable in flush valve embodiments.

Respective proximate and distal extents 12a and 12b together define a longitudinal body 12c therebetween with a longitudinal axis l defined therethrough. Body 12c includes external and internal circumferential surfaces 12c′ and 12c″, respectively, wherein inner circumferential surface 12c′ delineates a debris cup lumen 12d within which the filter means is disposed. At least one fluid ingress aperture 12e is defined in debris cup 12 that allows unimpeded passage of fluid therethrough. Aperture 12e established fluid communication between debris cup 12 and a fluid delivery conduit (not shown) as is known in the art.

The filter means disposed in debris cup lumen 12d at least comprises a screen member 16 having a longitudinal axis coincident with that of debris cup 12. Screen member 16 is desirably a generally cylindrical member as shown but may assume any geometry that is conducive to the operation of the present invention. Screen member 16 has a proximate extent 16a and a distal extent 16b that define a longitudinal screen body 16c therebetween. Filter body 16c includes an outer circumferential surface 16c′ disposed adjacent debris cup internal circumferential surface 12c″ so as to define a debris retention area 51 therebetween. Screen body 16c also includes an internal circumferential surface 16c″ that delineates a lumen through which clean fluid flows toward debris cup distal extent 12b. A plurality of flowthrough apertures 20, provided along at least a portion of screen body 16, permit fluid flow therethrough yet inhibit passage of the deleterious effluents in such fluid. Although apertures 20 are generally shown as cylindrical perforations, it is understood that apertures 20 may comprise any geometry or configuration (i.e., small slots, notches, etc.) wherein effluents are denied passage therethrough. Apertures 20 are of sufficient size and quantity such that effluents that are denied egress therethrough do not congregate along circumferential surfaces 16c′ and 16c″ of screen body 16. Such effluents are collected and retained in area 51 until maintenance of filter assembly 10 is effected by removal and cleaning of debris cup 12 and screen member 16 as an integral unit (thereby preventing release of the collected debris downstream of the fluid input).

Screen member 16 is desirably fabricated from a micro-perforated stainless steel sheet that forces fluid to flow from the outside of the screen member through the micro-perforations (such as apertures 20 shown herein). Stainless steel provides the advantages of enhanced resistance to corrosion, erosion and deformation, particularly when screen member 16 assumes a generally cylindrical configuration. A stainless steel surface also exhibits inherent smoothness such that particles are not collected thereon. It is understood, however, that screen member 16 may be produced from a material selected from metals, plastics, composites and any combination thereof that is conducive to the operation of the present invention.

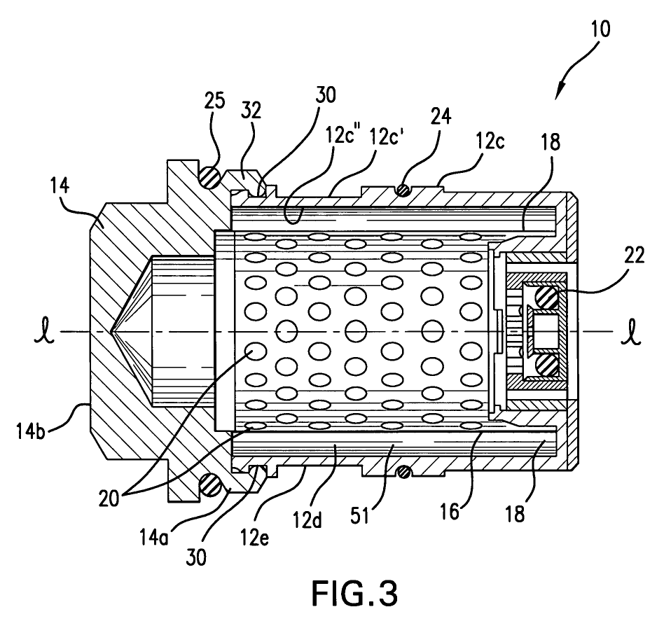

To effect sufficient retention of screen member 16 in debris cup 12 and further effect operation of filter assembly 10 as an integral unit, cap 14 includes a securement extent 14a that engages debris cup proximate extent 12a. As shown in FIGS. 2, 3 and 4, debris cup proximate extent 12a has one or more annular grooves 30 that cooperate with corresponding one or more annular tongues 32 provided at cap securement extent 14a, thereby effecting a snap-tight engagement therebetween. It is understood that that the same detachable securement function is attained by providing grooves on cap securement extent 14a for engagement of corresponding tongues provided on debris cup proximate extent 12a. It is further understood that alternate detachable fastening means are anticipated for use with the present invention without departing from the scope thereof. Debris cup 12 and cap 14 may connect to one another via a threaded connection, friction fit or combination thereof or via any other means that permits screen member 16 and debris cup 12 to remain attached to cap 14 upon removal of filter assembly 10 from a sanitary housing. In this configuration, screen member 16 and debris cup 12 may be removed from a sanitary housing as an integral unit for easy and economical cleaning and replacement thereof without effecting costly repairs to the sanitary housing itself.

To effect enhanced sealing capability, O-rings 24 and 25 (or comparable seals) are electively disposed relative to debris cup body 12c and cap 14 so as to have the at least one fluid ingress aperture 12e therebetween. Cap 14 further includes a gripping extent 14b that accommodates grasping of filter assembly 10 during installation, maintenance and removal thereof relative to a sanitary housing. Gripping extent 14b desirably includes a fastening element such as integral cap nut 26 (shown in the figures) that facilitates adjustment of cap 14 either by hand or with the assistance of one or more tools. Cap nut 26 may be further adapted to include visual, audio and/or tactile indices (not shown) that indicate proper opening and closure of cap 14 relative to debris cup 12. Such indices do not form part of the present invention.

At least one of debris cup 12 and cap 14 is desirably fabricated from plastic so that filter assembly 10 exhibits optimum corrosion resistance as well as snap-fit engagement between cap 14 and debris cup 12. This configuration permits a slight interference fit with screen member 16 to effect a better seal. It is understood, however, that the debris cup and cap may be produced from any other material that is conducive to operation of the present invention without departing from the scope thereof.

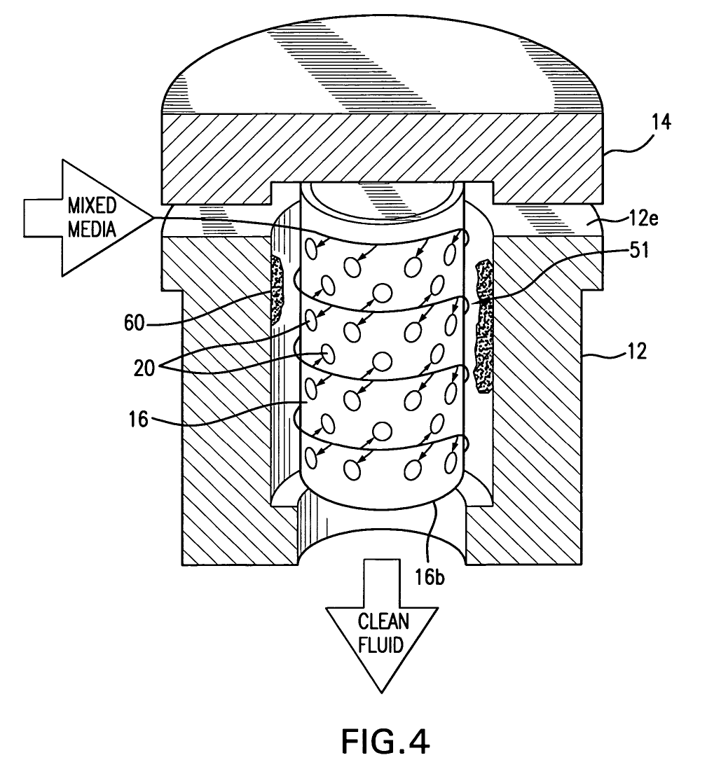

Referring to FIG. 4, operation of filter assembly 10 may now be described. Fluid arrives from a fluid delivery conduit (not shown) to filter assembly 10 via fluid ingress apertures 12e. The fluid traverses outer circumferential surface 16c′ of screen member and enters apertures 20 along the length of screen body 16c. Debris within the fluid is isolated in area 51 and retained therein (as indicated by reference numeral 60) while the fluid itself traverses each aperture 20 and arrives in the lumen of screen body 16. The clean fluid finally departs filter assembly 10 through debris cup distal extent 12b, yet collected debris 60 remains isolated in area 51. Upon accumulation of debris in area 51, a user grasps cup 14 and removes debris cup 12 and screen member 16 removed as a single unit. Upon such removal, the unit (and particularly area 51) may be cleaned, or any of debris cup 12, cap 14 and screen member 16 may be easily replaced without effecting protracted repairs to the sanitary housing within which filter assembly 10 is employed.

The present invention thereby provides a filter assembly that effectively realizes enhanced filtering properties by placing both filter means and debris collection means along a fluid flow path (thereby saving materials and enhancing the filtering function by eliminating the need to place one downstream of the other). The filter assembly taught herein maximizes the effective surface area of the filter means (via the screen member) and prevents any debris from entering the downstream water system during regular maintenance. The wash down effect achieved by the present invention further diminishes the time and resources required for service thereof while elongating the time between consecutive maintenance operations. This is possible because the filter screen and the debris cup, along with all the trapped debris, are removed as a complete unit in a simple, yet effective, configuration.

Various changes to the foregoing described and shown structures are now evident to those skilled in the art. The matter set forth in the foregoing description and accompanying drawings is therefore offered by way of illustration only and not as a limitation. Accordingly, the particularly disclosed scope of the invention is set forth in the following claims.

What is claimed is:

1. A filter assembly for use in sanitary fittings, comprising:
a debris cup releasably attached to a cap so as to retain a filter means thereby; said debris cup having a proximate extent at which a cap engagement means is defined and a distal extent from which filtered fluid departs said filter assembly; said proximate and distal extents defining a longitudinal body therebetween; said body having an internal circumferential surface defining a lumen within which said filter means is disposed and at least one fluid ingress aperture that allows unimpeded passage of fluid therethrough; said internal circumferential surface of said debris cup defining a debris reservoir relative to said filter means within which debris from said filtered fluid is isolated;
a cap having a securement extent that engages said cap engagement means and a gripping extent for grasping said filter assembly during installation, maintenance and removal thereof relative to said sanitary fitting;
wherein said debris cup, said cap and said filter means are unitarily removable from said sanitary housing.

2. The filter assembly of claim 1, wherein said filter means comprises a generally cylindrical screen member having proximate and distal extents defining a screen member body therebetween, said screen member body having an outer circumferential surface adjacent said debris cup internal circumferential surface, said circumferential surfaces delineating said debris reservoir thereby, and said screen member body further having a plurality of apertures defined through at least a portion thereof.

3. The filter assembly of claim 2, wherein said screen member is made of a micro-perforated stainless steel sheet.

4. The filter assembly of claim 1, wherein said debris cup proximate extent and said cap securement extent are releasably connected by one of a threaded connection, friction fit, snap-tight engagement or any combination thereof.

5. The filter assembly of claim 4, wherein snap-tight engagement is effected by cooperation of at least one annular groove, provided on one of said debris cup proximate extent and said cap securement extent, and at least one corresponding annular tongue, provided at the other of said debris cup proximate extent and said cap securement extent.

6. The filter assembly of claim 1, wherein said cap gripping extent includes an integral fastening element.

7. The filter assembly of claim 1, wherein at least one of said debris cup and said cap is fabricated from plastic.

8. A sanitary installation, comprising:
a sanitary fitting; and
a filter assembly disposed in fluid communication with said sanitary fitting so as to remove debris from fluid prior to delivery of said fluid to said sanitary fitting, said filter assembly comprising:
a debris cup releasably attached to a cap so as to retain a filter means thereby; said debris cup having a proximate extent at which a cap engagement means is defined and a distal extent from which filtered fluid departs said filter assembly; said proximate and distal extents defining a longitudinal body therebetween; said body having an internal circumferential surface defining a lumen within which said filter means is disposed and at least one fluid ingress aperture that allows unimpeded passage of fluid therethrough; said internal circumferential surface of said debris cup defining a debris reservoir relative to said filter means within which debris from said filtered fluid is isolated;
a cap having a securement extent that engages said cap engagement means and a gripping extent for grasping said filter assembly during installation, maintenance and removal thereof relative to said sanitary fitting;
wherein said debris cup, said cap and said filter means are unitarily removable from said sanitary housing.

9. The sanitary installation of claim 8, wherein said sanitary fitting is selected from a group of sanitary fittings including, but not limited to, faucets, bath fillers, shower control valves, flush valves and equivalents thereof.

10. The sanitary installation of claim 8, wherein said filter means comprises a generally cylindrical screen member having proximate and distal extents defining a screen member body therebetween, said screen member body having an outer circumferential surface adjacent said debris cup internal circumferential surface, said circumferential surfaces delineating said debris reservoir thereby, and said screen member body further having a plurality of apertures defined through at least a portion thereof.

11. The sanitary installation of claim 10, wherein said screen member is made of a micro-perforated stainless steel sheet.

12. The sanitary installation of claim 8, wherein said debris cup proximate extent and said cap securement extent are releasably connected by one of a threaded connection, friction fit, snap-tight engagement and any combination thereof.

13. The sanitary installation of claim 12, wherein snap-tight engagement is effected by cooperation of at least one annular groove, provided on one of said debris cup proximate extent and said cap securement extent, and at least one corresponding annular tongue, provided at the other of said debris cup proximate extent and said cap securement extent.

14. The sanitary installation of claim 8, wherein said cap gripping extent includes an integral fastening element.

15. The sanitary installation of claim 8, wherein at least one of said debris cup and said cap is fabricated from plastic.
